(19) United States
(12) Patent Application Publication
(10) Pub. No.: US 2026/0021467 A1
(43) Pub. Date: Jan. 22, 2026

(54) MOBILE SYSTEM AND METHOD FOR PFAS EFFLUENT TREATMENT

(71) Applicant: United States of America as Represented by The Secretary of The Army, Alexandria, VA (US)

(72) Inventors: Victor F Medina, Clinton, MS (US); Scott A Waisner, Vicksburg, MS (US); Charles C Ellison, Vicksburg, MS (US); Jose Mattei-Sosa, Vicksburg, MS (US); Jacob M Lalley, Vicksburg, MS (US); Christopher S Griggs, Vicksburg, MS (US)

(21) Appl. No.: 19/343,841

(22) Filed: Sep. 29, 2025

Related U.S. Application Data
(62) Division of application No. 16/854,874, filed on Apr. 21, 2020.

(51) Int. Cl. B01J 20/20; C02F 1/00; C02F 1/28; C02F 1/42; C02F 9/00; C02F 101/30; C02F 101/36; C02F 103/06

(52) U.S. Cl. CPC B01J 20/20; C02F 1/283; C02F 9/00; C02F 1/001; C02F 1/42; C02F 2001/422; C02F 2101/301; C02F 2101/36; C02F 2103/06

(57) ABSTRACT

In one embodiment, a system of PFAS (Per-Poly-fluorinated alkyl substances) effluent liquid treatment includes: a pump to pump a liquid received via an intake; a sediment filter to filter sediment from the liquid; a granular activated carbon (GAC) device, disposed downstream of the sediment filter, to remove organic contaminants from the liquid; one (preferably two) or more ion exchange resin columns, disposed downstream of the GAC device, to remove PFAS constituents from the liquid; and a plurality of control valves being controlled to direct the liquid to flow along one or more liquid flow paths through the ion exchange resin columns so as to adjust a rate of processing the liquid by the ion exchange resin columns. Directing the flow takes into consideration factors including any minimum rate of processing, any maximum amount of waste generation, and any target remaining PFAS contamination in the liquid after processing.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees.

### BACKGROUND

### Field of the Invention

The present invention relates to PFAS (Per-Poly-fluorinated alkyl substances) effluent treatment, and, more particularly but not exclusively, to mobile system and method for PFAS effluent treatment.

### Description of the Related Art

This section introduces aspects that may help facilitate a better understanding of the invention. Accordingly, the statements of this section are to be read in this light and are not to be understood as admissions about what is prior art or what is not prior art.

PFAS have been used in aqueous film-forming foams for about 50 years because they are very effective at suppressing fuel fires. Consequently, these contaminants are frequently found on military installations that have firefighting training and maintenance areas, including in the firefighting areas, in washout areas, and in collected groundwater.

PFAS are also found in many other commercial products, such as non-stick surfaces and water repellent fabrics. As such, PFAS contaminated water is also widely found resulting from non-military activities.

According to the Environmental Protection Agency (EPA), PFAS are persistent, bioaccumulate in organisms, and are toxic at very low levels. PFAS-contaminated sites require remediation and cleanup to protect human health and the environment. The EPA has established a Lifetime Health Advisory of 70-ppt for perfluorooctanesulfonic acid (PFOS) and perfluorooctanoic acid (PFOA), both part of the PFAS family of chemicals. The agency also has published a roadmap for PFAS, indicating that maximum contaminant levels for these compounds will soon be established. For example, the EPA drinking water health advisory is 0.070 ug/L. There are at least 401 active or closed Department of Defense installations or bases that have potential PFOS or PFOA release, with 36 sites having been identified to date where drinking water levels of PFOS and PFOA exceed the lifetime health advisory levels as defined by the EPA.

Effluent creates logistical issues when it comes to storage, transportation, and eventual treatment; additional, it is a liability until the final treatment or disposal. There is a great need for a technology that will safely decommission water-based PFAS contamination while reducing logistical issues and liabilities.

### SUMMARY

The present invention was developed to address the need for a robust, versatile, and adaptable approach to treat PFAS effluent. Research and development has led to novel deployable PFAS effluent treatment system and method. The system can be trailer-mounted and have its own generator so that it can operate virtually anywhere as a mobile unit. A cartridge filter is used to remove sediment followed by a granular activated carbon (GAC) treatment for removal of oils, greases, and natural organic carbon. These precede one, two, or more canisters/columns of ion exchange material (it is general practice to have 2 or more to insure complete treatment, but one vessel is possible), which is an ion exchange resin (e.g., Purofine produced by Purolite or similar product) that has been shown to have a very high exchange affinity for PFAS constituents. The system is used to treat PFAS-contaminated water to the lifetime health advisory levels established by the EPA.

The present invention advances the science of PFAS remediation and water/wastewater treatment. Embodiments of the present invention encompass systems and methods for (1) pumping water into the system and through the system, (2) treatment of constituents that may interfere with PFAS removal, (3) PFAS removal, (4) monitoring the system operation, such as pressure and flow (instantaneous and cumulative), and (5) control systems for easy operation and monitoring, including allowing remote and/or unmonitored operation.

Certain challenges are involved when (1) treating sites with high sediment concentration, (2) sites with very high organic content, or (3) sites with very high salt concentration. These challenges are overcome by employing a pretreatment process to remove sediment (e.g., using a sediment filter) to prevent sediment clogging in the apparatus and using the granular activated carbon (GAC) column to remove organic compounds including greases and oils that may interfere with effective PFAS treatment. Higher salinities can be managed using larger quantities of the ion exchanges resins.

According to some embodiments of the present invention, exemplary techniques include (1) an interchangeable system of treatment tanks that allow for efficient use around, for example, 1 gpm, 5 gpm and 10 gpm, (2) effective pre-treatment steps to allow for use in a wide range of applications, and (3) a versatile control system that allows for remote monitoring and operation and unmonitored operations with automatic shutoffs if problems occur.

In accordance with an aspect of the present invention, a method of PFAS effluent liquid treatment comprises: receiving a liquid containing PFAS via an intake; pumping the liquid to a sediment filter to filter sediment using a pump; directing the liquid exiting the sediment filter to a granular activated carbon (GAC) device to remove organic contaminants; directing the liquid exiting the GAC device to one (preferably two) or more ion exchange resin columns to remove PFAS constituents; and adjusting a rate of processing the liquid through the one or more ion exchange resin columns.

In some embodiments, a plurality of ion exchange resin columns are used, and the method further comprises specifying one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment. The rate of processing the liquid through the ion exchange resin columns is adjusted based on the one or more factors. When multiple factors are specified, the method further comprises prioritizing the multiple factors, and adjusting the rate of processing the liquid through the ion exchange resin columns based on the prioritized factors.

Although it is possible that a single larger vessel can be used, in most embodiments, a plurality of ion exchange resin columns are used, some of which have different PFAS decontamination performance levels or capacity levels or both performance and capacity levels. Adjusting the rate of processing comprises one or more of adjusting the flow rate of the liquid using the pump or directing the flow of the liquid selectively through some or all of the ion exchange resin columns and bypassing none to some others of the ion exchange resin columns. A number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing. When a plurality of parallel ion exchange flow paths exist each including a GAC device coupled in series with a plurality of ion exchange resin columns, the directing and bypassing comprise directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.

In some embodiments, the method further comprises sampling the liquid at one or more sample points along a liquid flow path of the liquid and, based on sampling the liquid, performing at least one of adjusting the rate of processing the liquid through the ion exchange resin columns or redirecting the liquid to a different liquid flow path. Adjusting the rate of processing comprises one or more of adjusting the flow rate of the liquid using the pump, or directing the flow of the liquid selectively through some or all of the ion exchange resin columns and bypassing none to some others of the ion exchange resin columns. Redirecting the liquid comprises redirecting the flow of the liquid along the different liquid flow path selectively through some or all of the ion exchange resin columns and bypassing none to some others of the ion exchange resin columns.

In accordance with another aspect of the invention, a system of PFAS effluent liquid treatment comprises: a pump to pump a liquid received via an intake; a sediment filter to filter sediment from the liquid; a GAC device, disposed downstream of the sediment filter, to remove organic contaminants from the liquid; one (preferably two) or more ion exchange resin columns, disposed downstream of the GAC device, to remove PFAS constituents from the liquid; and a plurality of control valves being controlled to direct the liquid to flow along one or more liquid flow paths through the one or more ion exchange resin columns so as to adjust a rate of processing the liquid by the one or more ion exchange resin columns.

In some embodiments, the system includes a plurality of the ion exchange resin columns and further comprises a computer-programmable control system programmed to: receive user input of one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment; and adjust the rate of processing the liquid through the ion exchange resin columns based on the one or more factors. When multiple factors are specified, the computer-programmable control system is programmed to receive user input of prioritizing the multiple factors and adjust the rate of processing the liquid through the ion exchange resin columns based on the prioritized factors.

In specific embodiments, the system includes a plurality of the ion exchange resin columns, some of which have different PFAS decontamination performance levels or capacity levels or both performance and capacity levels, and further comprises a computer-programmable control system programmed to perform one or more of adjusting the flow rate of the liquid using the pump or directing the flow of the liquid selectively through some or all of the ion exchange resin columns and bypassing none to some others of the ion exchange resin columns. A number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing. When the system includes a plurality of parallel ion exchange flow paths each including a GAC device coupled in series with a plurality of ion exchange resin columns, the directing and bypassing comprise directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.

In some embodiments, the system further comprises one or more sampling points along the one or more liquid flow paths of the liquid from which to sample the liquid and a computer-programmable control system programmed to perform, based on sampling the liquid, at least one of adjusting the rate of processing the liquid through the ion exchange resin columns or redirecting the liquid to one or more different liquid flow paths. Adjusting the rate of processing comprises one or more of adjusting the flow rate of the liquid using the pump, or directing the flow of the liquid selectively through some or all of the ion exchange resin columns and bypassing none to some others of the ion exchange resin columns. Redirecting the liquid comprises redirecting the flow of the liquid along one or more different liquid flow paths selectively through some or all of the ion exchange resin columns and bypassing none to some others of the ion exchange resin columns.

In specific embodiments, the system further comprises a generator to supply power to the system and a mobile platform on which the system is disposed. The system comprises a plurality of parallel sediment filter flow paths each including a sediment filter and a control valve being used to direct the flow of the liquid selectively through any or all of the plurality of parallel sediment filter flow paths.

Yet another aspect of this invention is directed to a computer program product for controlling a PFAS effluent liquid treatment system, which includes a pump to pump a liquid received via an intake, a sediment filter to filter sediment from the liquid, a GAC device, disposed downstream of the sediment filter, to remove organic contaminants from the liquid, one (preferably two) or more ion exchange resin columns, disposed downstream of the GAC device, to remove PFAS constituents from the liquid, and a plurality of control valves. The computer program product is embodied on a non-transitory tangible computer readable medium, and comprises computer-executable code for controlling the plurality of control valves to direct the liquid to flow along one or more liquid flow paths through the one or more ion exchange resin columns so as to adjust a rate of processing the liquid by the one or more ion exchange resin columns.

In some embodiments, the system includes a plurality of the ion exchange resin columns, and the computer program product further comprises: computer-executable code for receiving user input of one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment; and computer-executable code for adjusting the rate of processing the liquid through the ion exchange resin columns based on the one or more factors.

In specific embodiments, the system includes a plurality of the ion exchange resin columns, some of which have different PFAS decontamination performance levels or capacity levels or both performance and capacity levels, and the computer program product further comprises computer-executable code for performing one or more of adjusting the flow rate of the liquid using the pump or directing the flow of the liquid selectively through some or all of the ion exchange resin columns and bypassing none to some others of the ion exchange resin columns. A number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing.

In some embodiments, the system includes a plurality of parallel ion exchange flow paths each including a GAC device coupled in series with a plurality of ion exchange resin columns, and the computer program product further comprises computer-executable code for directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.

Hence, embodiments of the present invention encompass techniques that make use of combinations of water treatment processes to allow the same system to be used at multiple sites with minimal modification. Advantageously, embodiments of the present invention can be used to effectively treat PFAS contaminated water from a variety sites and a wide range of environmental conditions. The treatment system conserves water and can substantially reduce disposal costs for wastewater. The treatment system reclaims a significant portion of water that can be reused, thereby reducing water needs greatly. Treated water can also be returned to the environment and the volume of water requiring disposal can be reduced significantly.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 illustrates a PFAS effluent treatment system according to an embodiment of the present invention.

FIG. 2 illustrates a PFAS effluent treatment system according to another embodiment of the present invention.

FIG. 3 illustrates a PFAS effluent treatment system according to another embodiment of the present invention.

FIG. 4 is a flow diagram of a PFAS effluent treatment process according to an embodiment of the present invention.

FIG. 5 depicts an exemplary computer-programmable control system or device configured to control the PFAS effluent treatment process according to an embodiment of the present invention.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

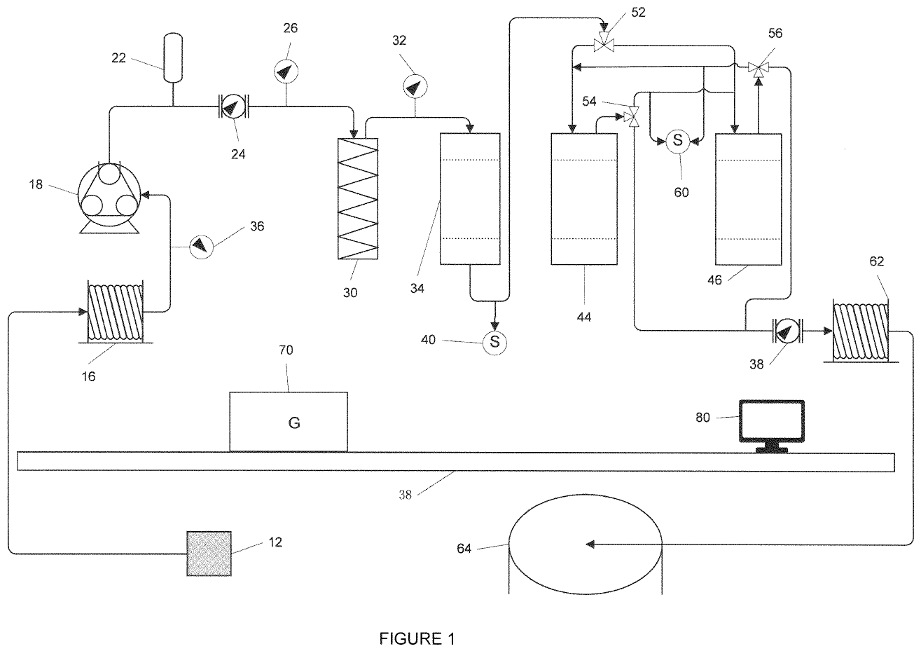

FIG. 1 illustrates a PFAS effluent treatment system 10 according to an embodiment of the present invention. The effluent liquid enters the system 10 via an intake 12, which may be a floating intake screen, into a hose arranged on a first hose reel 16. A pump 18 draws the liquid into the system and drives the liquid downstream. A vacuum gauge 36 between the first hose reel 16 and the pump 18 measures the net positive suction head near the pump inlet. A pulse dampener 22 is used to dampen the pumping pulses in the downstream fluid flow. A flow meter 24 measures the flow rate into the system 10. A first pressure gauge 26 measures the fluid pressure just upstream of the entrance of a sediment filter 30. A second pressure gauge is disposed between the sediment filter 30 and a granular activated carbon (GAC) unit or device 34. The vacuum, pressure, and flow readings are monitored during the operation of the system 10.

In specific embodiments, the pump 18 is a Bredel 40 hose pump made by Watson-Marlow Fluid Technology (Wilmington, MA). It is a variable speed pump designed for low maintenance, is self-priming, and has a robust design for protection against aggressive chemicals or abrasives. The pump uses a peristaltic process, so that the water does not actually touch the working parts, making service much safer in environmentally hostile situations. A similar pump could be substituted.

Chemical resistant tubing (e.g., ¾ in. and 1 in. internal diameter) may be used to connect the various unit processes. Tubing is also available to hook the treatment apparatus to the influent source (via the intake 12) and production water container (treated water holding tank 64 described herein below). These two tubing lengths are kept on hose reels 16, 62 (e.g., Reelcraft D9300 and D9400, Reelcraft Industries, Inc., Columbia City, IN).

The pretreatment stage encompassing the sediment filter 30 and the GAC 34 anticipates constituents that may interfere with effective treatment and provides appropriate pretreatments. The sediment filter 30 prevents sediment clogging in the apparatus. Typically, because relatively small sediment particles are present in PFAS decontamination situations, a cartridge filter is more efficient and effective for removing the finer sediment particles. The cartridge filter (e.g., Pentek 150235 4.5″×20″ cartridge) is more compact and easier to mount and transport on a mobile platform such as a trailer 38.

In specific embodiments, the GAC 34 is a GAC bed (e.g., part number W-G1665DT-US) consisting of coal based activated carbon with 12×40 mesh size and a bulk density of 27.5 lb/ft³ (440 kg/m³). Coal-based activated carbon has a broad range of micropore sizes, which is particularly effective for water treatment. The GAC 34 is used to remove organic compounds including greases, oils, and natural organic carbon.

The pressure readings at the vacuum gauge 36 and pressure gauges 26, 32 and the flow rate readings at the flow meters 24 and 38 are used to detect any clogging (unusual pressure buildup or flow rate drop) or leaking (discrepancy between the two flow rate readings). In such instances, a visual warning signal and/or an audible alarm can be generated to alert the user/operator. An auto shutoff feature can also be added to protect the system. At the end of the pretreatment stage is a sampling point 40 for taking a small sample of the liquid to check for pretreatment performance and the like.

The next stage is PFAS treatment, in which single use ion exchange (IX) resins are used. The resins are housed in IX resin columns or canisters 44, 46 which are connected via flow lines (hoses) and control valves 52, 54, 56 (e.g., 3-way). By controlling the control valves 52, 54, 56, the liquid flow can be directed, typically, through the first canister 44 for primary treatment and then the second canister 46 for secondary/polishing treatment. Alternatively, they may be controlled to direct the liquid flow through only one of the two canisters 44, 46, or to the second canister 46 first for primary treatment and then the first canister 44 for secondary treatment. One or more sampling points 60 are provided for taking a small sample of the liquid to check for treatment performance and the like. The sample can be tested using liquid chromatography double mass spectrometry (LLMSMS), colormetric method, or the like (including new methods currently being developed). While the two IX resin canisters 44, 46 are typically the same size having the same PFAS treatment capacity and performance levels, they may be different in size, PFAS treatment capacity, and PFAS treatment performance. In specific embodiments, the IX resin canisters 44, 46 include media tanks (e.g., Applied Membranes YTP1865-4, 18″×65″) containing Purofine PFA694E produced by Purolite. The processed liquid flows through the exit hose kept on the second hose reel 62 into a treated water holding tank 64.

The treatment system 10 preferably has its own generator 70 for operations where electrical connection is not readily available. In specific embodiments, the generator is a 6-kW, 3-phase 240-VAC diesel generator (provided by Multiquip of Carson, California, WhisperWatt model TLG8SSK4F2). The generator has a 40-gallon sub-base fuel tank and a sound enclosure to keep noise at 68 dB (A) at 7 m (23 ft), which is helpful for communications or applications near residential areas or areas of work. It is also designed to be suitable for operation of sensitive electronic equipment. A grounding stake is used for safe operation. Fuel consumption varies from 0.37 to 0.69 gal/hr. Alternatively, the treatment system can operate by simply plugging it into a 240-VAC 3-phase 30-amp source.

The treatment system 10 preferably has its own computer programmable control system 80 for controlling the operation and storing data. It takes measurement readings from the flow meters 24, 38 and the vacuum gauge 36 and pressure gauges 26, 32, any input from the sampling points 40, 60, and provides control over the valves 52, 54, 56 (or other flow directing mechanisms or on/off switches) to direct the liquid flow for treatment processing. In one example, the valve 52 is switched to direct the flow to the first canister 44, and the valve 54 is switched to direct the flow to the second canister 46, and then the valve 56 is switched to direct the flow to the holding tank 64. In another example, the valve 52 is switched to direct the flow to the first canister 44, and the valve 54 is switched to direct the flow to the holding tank 64, bypassing the second canister 46. In another example, the valve 52 is switched to direct the flow to the second canister 46, and the valve 56 is switched to direct the follow to the holding tank 64, by passing the first canister 44. In yet another example, the valve 52 is switched to direct the flow to the second canister 46, and the valve 56 is switched to direct the flow to the first canister 44, and then the valve 54 is switched to direct the flow to the holding tank 64, reversing the order of processing between the first canister 44 and the second canister 46 as compared to the first example.

In specific embodiments, the computer control is provided by an electronic process monitoring and control system built around the EZ-Touch input/output (I/O) control processor. This inexpensive unit has a 25 cm (10 in.) pressure-sensitive touch panel control that can be programmed to form customized control and information screens. The processor uses a Modular I/O, up to 24 channels. The processor also has communications protocols for off the shelf programmable logic controllers (PLCs) and variable frequency drives (VFDs), and includes development software for rapid, custom builds of control protocols, which can be developed using a computer and uploaded to the control panel. The control system 80 is mounted on the trailer 38 in a protective case where it can be easily accessed.

The integrated system is preferably a mobile system that is mounted on the trailer 38. In one embodiment, the trailer bed is about 16 ft (4.9 m) long and 6 ft 5 in (2 m) in width. The mobile PFAS treatment system 10 has been used to treat a runoff collection pond from a firefighting training complex with a PFOS concentration of up to 360 ug/L. The treatment system performed continuous operation for 67.5 hours to process about 80,000 gallons of PFAS contaminated water and produce about 43,000 gallons of treated water.

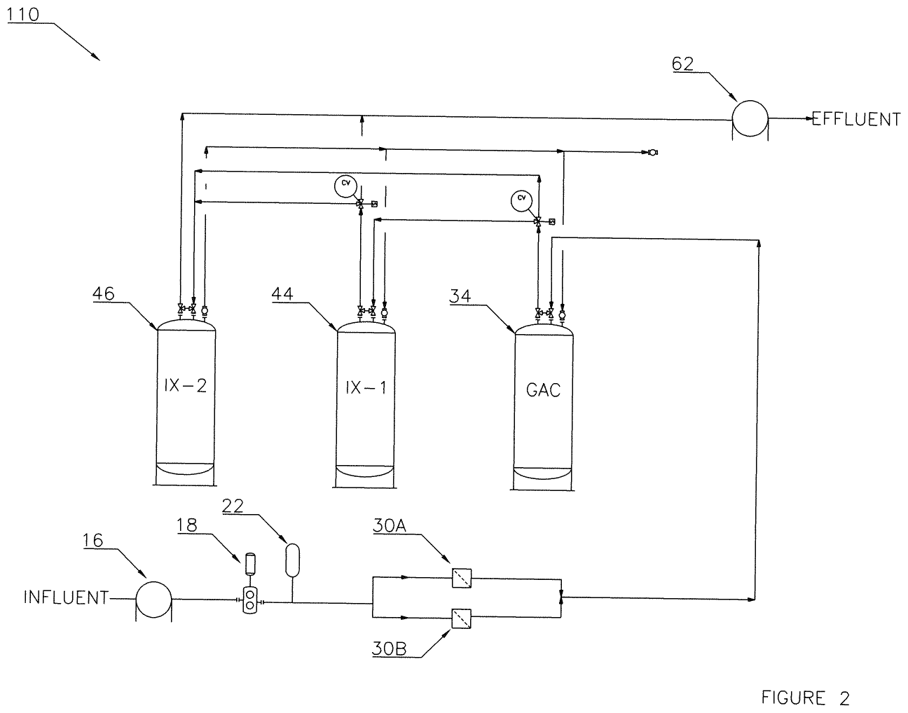

FIG. 2 illustrates a PFAS effluent treatment system 110 according to another embodiment of the present invention. The system 110 is similar to the system 10 of FIG. 1 and many of the same reference characters are used. The main difference is that FIG. 2 shows two cartridge filters 30A, 30B arranged in parallel on parallel sediment filter flow paths that split and then merged back together. This allows the use of two smaller cartridge filters 30A, 30B to achieve the same flow capacity. In specific embodiments, the cartridge filters 30A, 30B each have a 20″ Big Blue HFPP 1″ filter housing outfitted with 1 micron 4-layer filters that is rated for 10 gpm each. In addition, a control valve at the point of splitting can be used to direct the liquid flow to only one of the cartridge filters; in this way, the process can keep running using one cartridge filter while the other cartridge filter is being replaced or serviced (for easy changeout). The control valves for directing flow through the IX resin canisters 44, 46 are configured differently from those (52, 54, 56, 58) in FIG. 1, illustrating the different ways of directing the liquid flow.

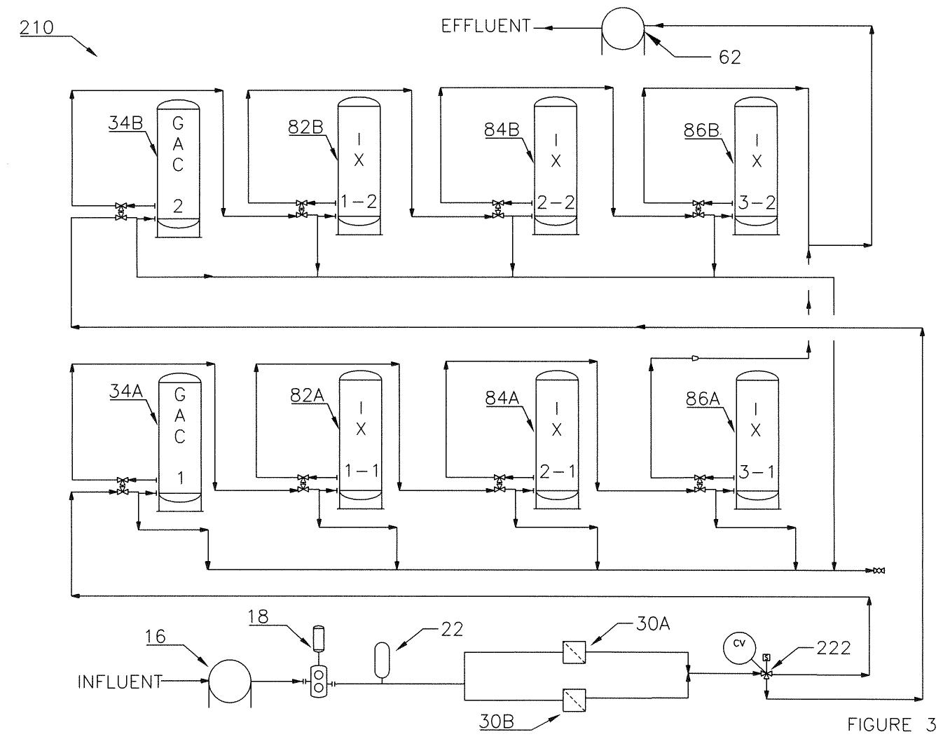

FIG. 3 illustrates a PFAS effluent treatment system 210 according to another embodiment of the present invention. The system 210 is similar to the system 110 of FIG. 2 and some of the same reference characters are used. The main difference is that FIG. 3 shows two GACs 34A, 34B arranged in parallel ion exchange flow paths that are split after a first control valve 222. In each of the parallel ion exchange flow paths, three IX resin canisters (82A, 84A, 86A and 82B, 84B, 86B) are arranged in series, respectively. A plurality of control valves are provided to direct the liquid flow to pass through or bypass any of the IX resin canisters. Each canister is rated for a lower capacity (e.g., 2-2.5 gpm instead of 10 gpm). If both parallel ion exchange flow paths are open and used, the treatment process rate is about 4-5 gpm. If only one is open and used, the treatment process rate is 2-2.5 gpm. More process rate variations are possible by using different IX resin canisters having different sizes, PFAS treatment capacity, and PFAS treatment performance.

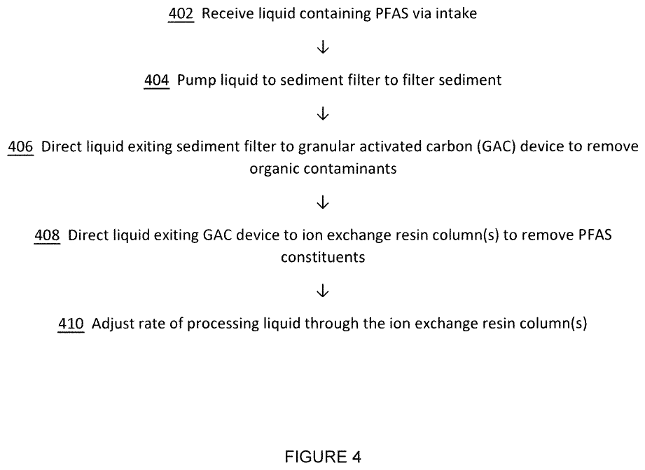

FIG. 4 is a flow diagram of the PFAS treatment process using the PFAS treatment apparatus according to an embodiment of the present invention. In step 402, the system 10 is used to receive a liquid containing PFAS via the intake 12. In step 404, the pump 18 is used to pump the liquid to a sediment filter 30 to filter sediment. In step 406, the system is used to direct the liquid exiting the sediment filter 30 to a granular activated carbon (GAC) device 34 to remove organic contaminants. In step 408, the system is used to direct the liquid exiting the GAC device 34 to one or more ion exchange resin columns 44, 46 (82, 84, 86) to remove PFAS constituents. In step 410, the system is used to adjust a rate of processing the liquid through the one or more ion exchange resin columns.

As discussed above, the system 10 facilitates variable treatment processing rate. In general, a faster rate gets the job done more quickly but a slower rate allows better removal of the PFAS constituents so as to produce treated liquid that has a relatively lower level of PFAS contamination. A slower rate also allows for the adsorptive/ion exchange processes to be more efficient, thereby producing a smaller amount of waste generation. As such, the user may specify one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment and desired efficient use of the ion exchange resin. The rate of processing the liquid through the ion exchange resin columns is adjusted based on the one or more factors. When multiple factors are specified, the user may prioritize the multiple factors and the rate of processing the liquid through the ion exchange resin columns may be adjusted based on the prioritized factors.

As mentioned above, some of the ion exchange resin columns may have different PFAS decontamination performance levels or capacity levels or both performance and capacity levels. In that case, the rate of processing can be adjusted by adjusting the flow rate of the liquid using the pump, or directing the flow of the liquid selectively through some or all of the ion exchange resin columns and bypassing none to some others of the ion exchange resin columns. The number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing.

In one example as shown in FIG. 3 and described above, the system 210 includes a plurality of parallel ion exchange flow paths each including a GAC device (34A, 34B) coupled in series with a plurality of ion exchange resin columns (82A, 84A, 86A and 82B, 84B, 86B). While FIG. 3 shows two parallel ion exchange flow paths, three or more parallel ion exchange flow paths are possible in other embodiments. The directing and bypassing includes directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.

As discussed above, during the PFAS treatment stage, one or more sampling points 60 are provided for taking a small sample of the liquid to check for treatment performance. Based on sampling the liquid at one or more sample points along the liquid flow path of the liquid, the user or the computer may adjust the rate of processing the liquid through the ion exchange resin columns, or redirect the liquid to a different liquid flow path, or both. The goal may be to increase the PFAS treatment processing rate without compromising the PFAS treatment, or to improve the PFAS treatment performance and reduce the waste generation by slowing the PFAS treatment processing rate or increasing/selecting different ion exchange resin columns used for processing or both.

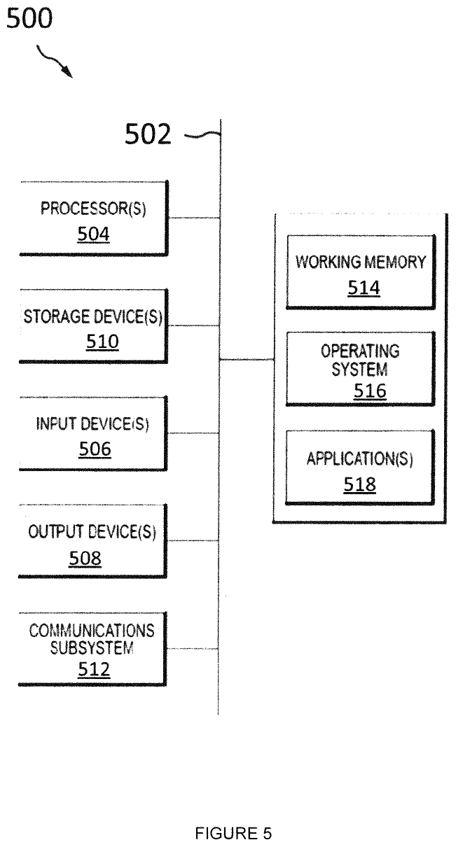

FIG. 5 depicts an exemplary computer-programmable control system or device 500 configured for use with the PFAS effluent treatment system (10, 110, 210) according to an embodiment of the present invention. An example of a computer system or device 500 may include an enterprise server, blade server, desktop computer, laptop computer, tablet computer, personal data assistant, smartphone, any combination thereof, and/or any other type of machine configured for performing calculations. Any computing devices encompassed by embodiments of the present invention may be wholly or at least partially configured to exhibit features similar to the computer system 500.

The computer device 500 of FIG. 5 is shown comprising hardware elements that may be electrically coupled via a bus 502 (or may otherwise be in communication, as appropriate). The hardware elements may include a processing unit with one or more processors 504, including without limitation one or more general-purpose processors and/or one or more special-purpose processors (such as digital signal processing chips, graphics acceleration processors, and/or the like); one or more input devices 506, which may include without limitation a remote control, a mouse, a keyboard, and/or the like; and one or more output devices 508, which may include without limitation a presentation device (e.g., controller screen), a printer, and/or the like. In some cases, an output device 508 may include, for example, a display subsystem, a printer, a fax machine, or non-visual displays such as audio output devices. The display subsystem may be a cathode ray tube (CRT), a flat-panel device such as a liquid crystal display (LCD), a projection device, or the like. The display subsystem may also provide a non-visual display such as via audio output devices. In general, use of the term “output device” is intended to include a variety of conventional and proprietary devices and ways to output information from computer system 500 to a user.

The computer system 500 may further include (and/or be in communication with) one or more non-transitory storage devices 510, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 500 can also include a communications subsystem 512, which may include without limitation a modem, a network card (wireless and/or wired), an infrared communication device, a wireless communication device and/or a chipset such as a Bluetooth device, 802.11 device, WiFi device, WiMax device, cellular communication facilities such as GSM (Global System for Mobile Communications), W-CDMA (Wideband Code Division Multiple Access), LTE (Long Term Evolution), and the like. The communications subsystem 512 may permit data to be exchanged with a network (such as the network described below, to name one example), other computer systems, controllers, and/or any other devices described herein. In many embodiments, the computer system 500 can further comprise a working memory 514, which may include a random access memory and/or a read-only memory device, as described above.

The computer device 500 also can comprise software elements, shown as being currently located within the working memory 514, including an operating system 516, device drivers, executable libraries, and/or other code, such as one or more application programs 518, which may comprise computer programs provided by various embodiments, and/or may be designed to implement methods, and/or configure systems, provided by other embodiments, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code can be stored on a non-transitory computer-readable storage medium, such as the storage device(s) 510 described above. In some cases, the storage medium might be incorporated within a computer system, such as computer system 500. In other embodiments, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 500 and/or might take the form of source and/or installable code, which, upon compilation and/or installation on the computer system 500 (e.g., using any of a variety of generally available compilers, installation programs, compression/decompression utilities, and the like), then takes the form of executable code.

It is apparent that substantial variations may be made in accordance with specific requirements. For example, customized hardware might also be used, and/or particular elements might be implemented in hardware, software (including portable software, such as applets, and the like), or both. Further, connection to other computing devices such as network input/output devices may be employed.

As mentioned above, in one aspect, some embodiments may employ a computer system (such as the computer device 500) to perform methods in accordance with various embodiments of the disclosure. According to a set of embodiments, some or all of the procedures of such methods are performed by the computer system 500 in response to processor 504 executing one or more sequences of one or more instructions (which might be incorporated into the operating system 516 and/or other code, such as an application program 518) contained in the working memory 514. Such instructions may be read into the working memory 514 from another computer-readable medium, such as one or more of the storage device(s) 510. Merely by way of example, execution of the sequences of instructions contained in the working memory 514 may cause the processor(s) 504 to perform one or more procedures of the methods described herein.

The terms “machine-readable medium” and “computer-readable medium,” as used herein, can refer to any non-transitory medium that participates in providing data that causes a machine to operate in a specific fashion. In an embodiment implemented using the computer device 500, various computer-readable media might be involved in providing instructions/code to processor(s) 504 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 510. Volatile media may include, without limitation, dynamic memory, such as the working memory 514.

Exemplary forms of physical and/or tangible computer-readable media may include a floppy disk, a flexible disk, hard disk, magnetic tape, or any other magnetic medium, a compact disc, any other optical medium, ROM, RAM, and the like, any other memory chip or cartridge, or any other medium from which a computer may read instructions and/or code. Various forms of computer-readable media may be involved in carrying one or more sequences of one or more instructions to the processor(s) 504 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 512 (and/or components thereof) generally can receive signals, and the bus 502 then can carry the signals (and/or the data, instructions, and the like, carried by the signals) to the working memory 514, from which the processor(s) 504 retrieves and executes the instructions. The instructions received by the working memory 514 may optionally be stored on a non-transitory storage device 510 either before or after execution by the processor(s) 504.

It should further be understood that the components of computer device 500 can be distributed across a network. For example, some processing may be performed in one location using a first processor while other processing may be performed by another processor remote from the first processor. Other components of computer system 500 may be similarly distributed. As such, computer device 500 may be interpreted as a distributed computing system that performs processing in multiple locations. In some instances, computer system 500 may be interpreted as a single computing device, such as a distinct laptop, desktop computer, tablet, cellular phone, or the like, depending on the context.

A processor may be a hardware processor such as a central processing unit (CPU), a graphic processing unit (GPU), or a general-purpose processing unit. A processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations.

Each of the calculations or operations discussed herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described herein. All features of the described systems are applicable to the described methods mutatis mutandis, and vice versa. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like. While the exemplary embodiments have been described in some detail, by way of example and for clarity of understanding, those of skill in the art will recognize that a variety of modification, adaptations, and changes may be employed.

As will be appreciated by one of ordinary skill in the art, the present invention may be embodied as an apparatus (including, for example, a system, a machine, a device, and/or the like), as a method (including, for example, a business process, and/or the like), or as any combination of the foregoing.

Embodiments of the invention can be manifest in the form of methods and apparatuses for practicing those methods.

Unless explicitly stated otherwise, each numerical value and range should be interpreted as being approximate as if the word “about” or “approximately” preceded the value or range.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

All documents mentioned herein are hereby incorporated by reference in their entirety or alternatively to provide the disclosure for which they were specifically relied upon.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A method of PFAS (Per-Poly-fluorinated alkyl substances) effluent liquid treatment, the method comprising:
receiving a liquid containing PFAS via an intake;
pumping the liquid to a sediment filter to filter sediment using a pump;
directing the liquid exiting the sediment filter to a granular activated carbon (GAC) device to remove organic contaminants;
directing the liquid exiting the GAC device to one or more ion exchange resin columns to remove PFAS constituents; and
adjusting a rate of processing the liquid through the one or more ion exchange resin columns.

2. The method of claim 1, wherein a plurality of ion exchange resin columns are used, the method further comprising:
specifying one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment;
wherein the rate of processing the liquid through the ion exchange resin columns is adjusted based on the one or more factors.

3. The method of claim 2, wherein multiple factors are specified, the method further comprising:
prioritizing the multiple factors; and
adjusting the rate of processing the liquid through the ion exchange resin columns based on the prioritized factors.

4. The method of claim 1, wherein a plurality of ion exchange resin columns are used, some of which have different PFAS decontamination performance levels or capacity levels or both performance and capacity levels, and wherein adjusting the rate of processing comprises one or more of:
adjusting the flow rate of the liquid using the pump; or
directing the flow of the liquid selectively through some or all of the ion exchange resin columns and bypassing none to some others of the ion exchange resin columns;
wherein a number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing.

5. The method of claim 4, wherein a plurality of parallel ion exchange flow paths exist each including a GAC device coupled in series with a plurality of ion exchange resin columns, and wherein the directing and bypassing comprise:
directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.

6. The method of claim 1, further comprising:
sampling the liquid at one or more sample points along a liquid flow path of the liquid; and
based on sampling the liquid, performing at least one of adjusting the rate of processing the liquid through the ion exchange resin columns or redirecting the liquid to a different liquid flow path.

7. The method of claim 6,
wherein adjusting the rate of processing comprises one or more of adjusting the flow rate of the liquid using the pump, or directing the flow of the liquid selectively through some or all of the ion exchange resin columns and bypassing none to some others of the ion exchange resin columns; and
wherein redirecting the liquid comprises redirecting the flow of the liquid along the different liquid flow path selectively through some or all of the ion exchange resin columns and bypassing none to some others of the ion exchange resin columns.

8. A system of PFAS (Per-Poly-fluorinated alkyl substances) effluent liquid treatment, the system comprising:
a pump to pump a liquid received via an intake;
a sediment filter to filter sediment from the liquid;
a granular activated carbon (GAC) device, disposed downstream of the sediment filter, to remove organic contaminants from the liquid;
one or more ion exchange resin columns, disposed downstream of the GAC device, to remove PFAS constituents from the liquid; and
a plurality of control valves being controlled to direct the liquid to flow along one or more liquid flow paths through the one or more ion exchange resin columns so as to adjust a rate of processing the liquid by the one or more ion exchange resin columns.

9. The system of claim 8, wherein the system includes a plurality of the ion exchange resin columns and further comprises a computer-programmable control system programmed to:
receive user input of one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment; and
adjust the rate of processing the liquid through the ion exchange resin columns based on the one or more factors.

10. The system of claim 9, wherein multiple factors are received, and wherein the computer-programmable control system is programmed to:
receive user input of prioritizing the multiple factors; and
adjust the rate of processing the liquid through the ion exchange resin columns based on the prioritized factors.

11. The system of claim 8, wherein the system includes a plurality of the ion exchange resin columns, some of which have different PFAS decontamination performance levels or capacity levels or both performance and capacity levels, and further comprises a computer-programmable control system programmed to perform one or more of:
adjusting the flow rate of the liquid using the pump; or
directing the flow of the liquid selectively through some or all of the ion exchange resin columns and bypassing none to some others of the ion exchange resin columns;
wherein a number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing.

12. The system of claim 11, wherein the system includes a plurality of parallel ion exchange flow paths each including a GAC device coupled in series with a plurality of ion exchange resin columns, and wherein the directing and bypassing comprise:
directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.

13. The system of claim 8, further comprising one or more sampling points along the one or more liquid flow paths of the liquid from which to sample the liquid and a computer-programmable control system programmed to perform, based on sampling the liquid, at least one of:
adjusting the rate of processing the liquid through the ion exchange resin columns; or
redirecting the liquid to one or more different liquid flow paths.

14. The system of claim 13,
wherein adjusting the rate of processing comprises one or more of adjusting the flow rate of the liquid using the pump, or directing the flow of the liquid selectively through some or all of the ion exchange resin columns and bypassing none to some others of the ion exchange resin columns; and
wherein redirecting the liquid comprises redirecting the flow of the liquid along one or more different liquid flow paths selectively through some or all of the ion exchange resin columns and bypassing none to some others of the ion exchange resin columns.

15. The system of claim 8, further comprising a generator to supply power to the system and a mobile platform on which the system is disposed.

16. The system of claim 8, wherein the system comprises a plurality of parallel sediment filter flow paths each including a sediment filter and a control valve being used to direct the flow of the liquid selectively through any or all of the plurality of parallel sediment filter flow paths.

17. A computer program product for controlling a PFAS (Per-Poly-fluorinated alkyl substances) effluent liquid treatment system, which includes a pump to pump a liquid received via an intake, a sediment filter to filter sediment from the liquid, a granular activated carbon (GAC) device, disposed downstream of the sediment filter, to remove organic contaminants from the liquid, one or more ion exchange resin columns, disposed downstream of the GAC device, to remove PFAS constituents from the liquid, and a plurality of control valves, the computer program product embodied on a non-transitory tangible computer readable medium, comprising:
computer-executable code for controlling the plurality of control valves to direct the liquid to flow along one or more liquid flow paths through the one or more ion exchange resin columns so as to adjust a rate of processing the liquid by the one or more ion exchange resin columns.

18. The computer program product of claim 17, wherein the system includes a plurality of the ion exchange resin columns, and wherein the computer program product further comprises:
computer-executable code for receiving user input of one or more factors including (i) a minimum rate of processing specified in view of a total amount of the liquid to be processed and a time period for completing the processing, (ii) a maximum amount of waste generation specified so as to limit waste generation from processing the liquid through the ion exchange resin columns in view of types and initial contamination levels of the PFAS constituents in the liquid prior to treatment, and (iii) target remaining PFAS contamination in the liquid after processing specified to achieve a target effectiveness level of removing the PFAS constituents from the liquid by the ion exchange resin columns in view of the types and initial contamination levels of the PFAS constituents in the liquid prior to treatment; and
computer-executable code for adjusting the rate of processing the liquid through the ion exchange resin columns based on the one or more factors.

19. The computer program product of claim 17, wherein the system includes a plurality of the ion exchange resin columns, some of which have different PFAS decontamination performance levels or capacity levels or both performance and capacity levels, and wherein the computer program product further comprises computer-executable code for performing one or more of:
adjusting the flow rate of the liquid using the pump; or
directing the flow of the liquid selectively through some or all of the ion exchange resin columns and bypassing none to some others of the ion exchange resin columns;
wherein a number of the ion exchange resin columns selected for directing the flow of liquid therethrough, and PFAS decontamination performance levels and PFAS decontamination capacity levels of the selected ion exchange resin columns, determine at least one of the rate of processing, an amount of waste generation, or a level of remaining PFAS contamination in the liquid after the processing.

20. The computer program product of claim 19, wherein the system includes a plurality of parallel ion exchange flow paths each including a GAC device coupled in series with a plurality of ion exchange resin columns, and wherein the computer program product further comprises:
computer-executable code for directing the flow of the liquid selectively through one or more of the plurality of parallel ion exchange flow paths and the corresponding GAC device and plurality of ion exchange resin columns in each said parallel ion exchange flow path being directed, and bypassing none to any of the plurality of parallel ion exchange flow paths and the corresponding GAC device and plurality of ion exchange resin columns in each said parallel ion exchange flow path being bypassed.
